(19) United States
(12) Patent Application Publication
(10) Pub. No.: US 2007/0063518 A1
(43) Pub. Date: Mar. 22, 2007

(54) AC/DC power unit to replace fuel burning engines

(76) Inventor: Michael William Galyen, Sacramento, CA (US)

Correspondence Address: Michael W. Galyen, 3753 Rock Island Dr, Sacramento, CA, 95827, US

(21) Appl. No.: 11/178,187

(22) Filed: Sep. 22, 2005

(51) Int. Cl. H02K 7/18; F03G 7/08; F02B 63/04

(52) U.S. Cl. 290/1 R

(57) ABSTRACT

The patent I am applying for is a AC/DC SELF GENERATING MOTOR SYSTEM to replace fuel burning engines. This system Will allow a vehicle to drive coast to coast to coast with out the need to refuel. The vehicle still uses it's alternator, a/c unit, power steering unit and smog pump original equipment on the vehicles. The AC/DC units will be environmentally and eco safe no pollutants, smog, free. Self generating system AC, vehicles system DC thus AC/DC system. Nondependent on fossil fuel.

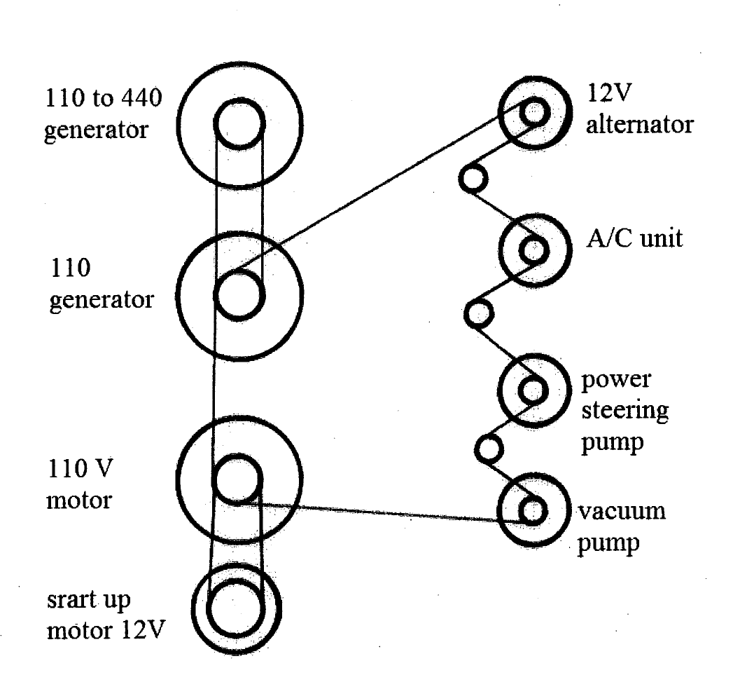

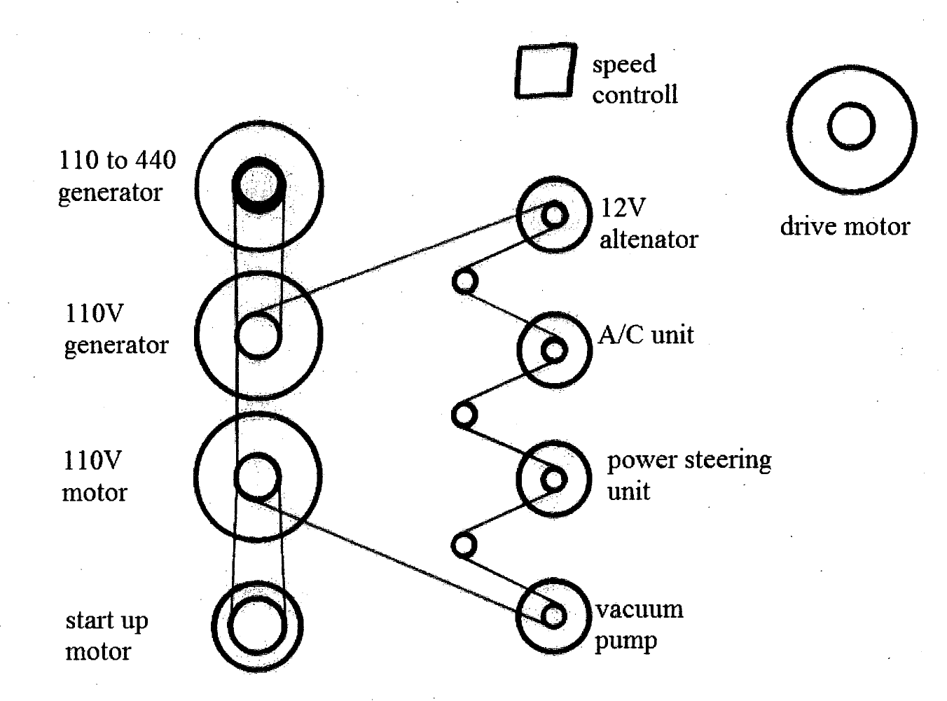

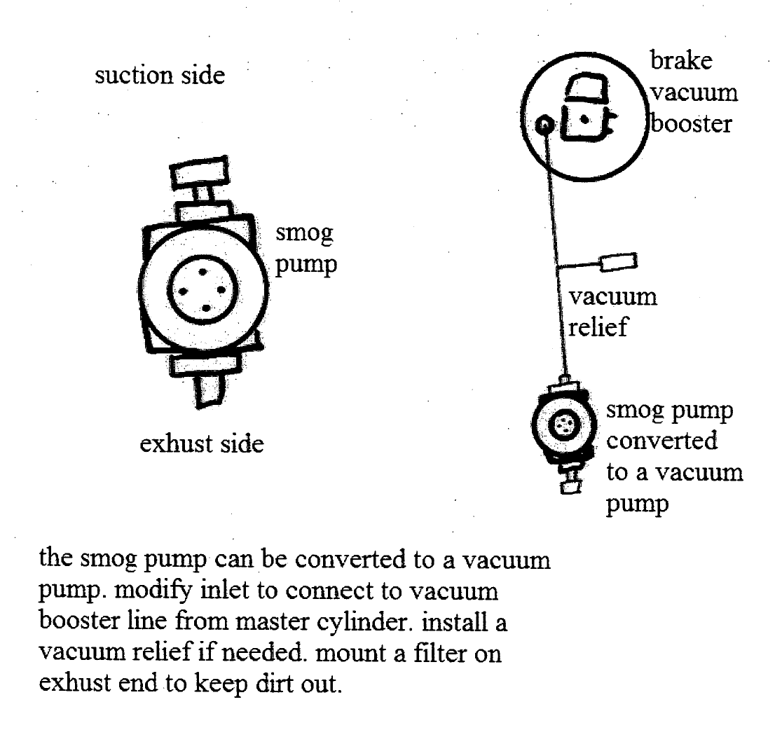

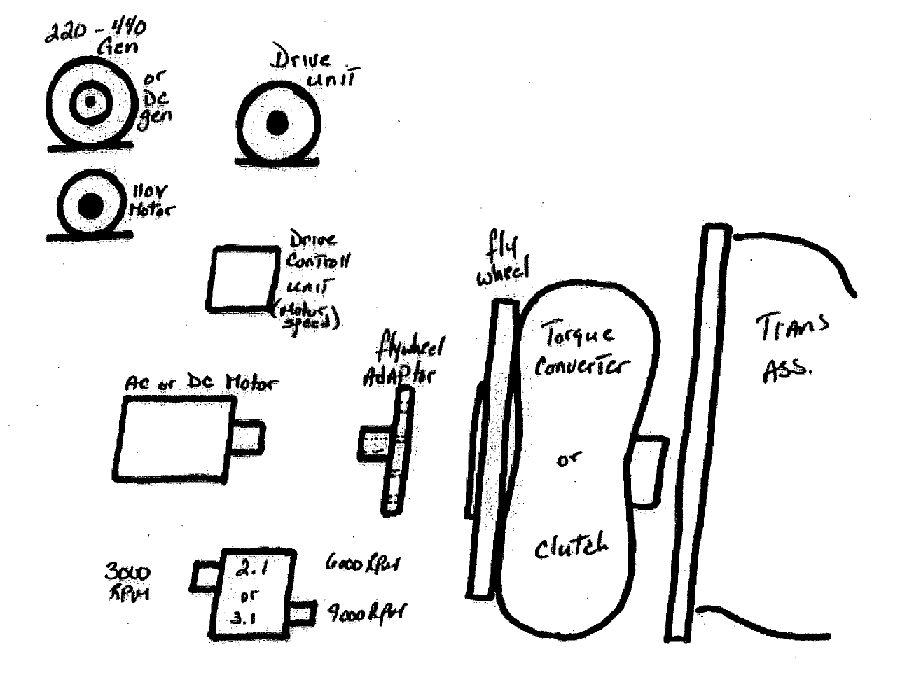

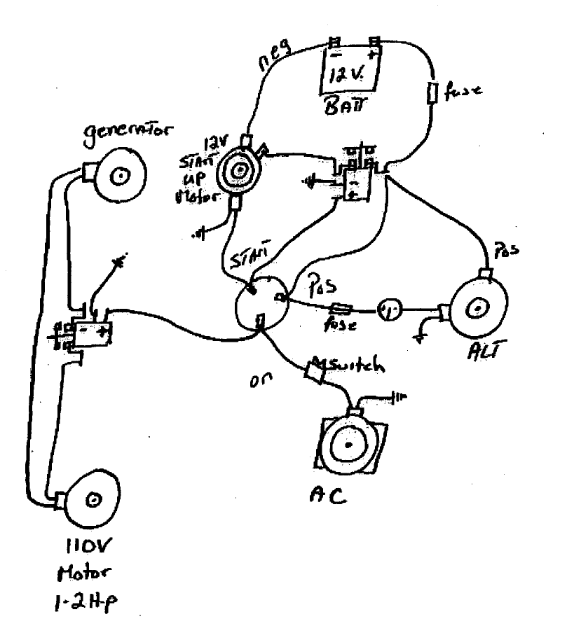

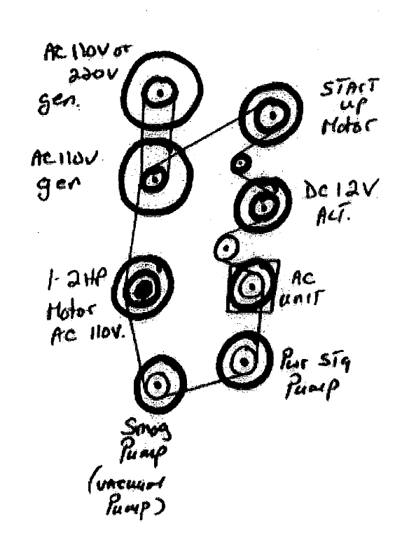

I am applying for a patent on an AC/DC power unit to replace fuel burning engines. With the AC/DC units running in the vehicles they become clean air vehicles. They do not create any exhaust emissions into the air. This makes the vehicle more environmentally and eco safe. The AC/DC power units will replace fuel burning engines dependant on crude oil to be refined to produce fuel for them to run on. Crude oil is a limited resource witch will some day run out. With the vehicle running on the AC/DC power units when they are started up, they will run until they are turned off. You will not have to stop for fuel. You will be able to drive coast to coast to coast without stopping for fuel.

The AC/DC units are like trains, diesel electric except that they run on self generating power instead of a diesel engine. These units can also be modified to be used by utility companies, instead of running a transmission they can a power generator to produce power locally. Now power can be produced in an urban area, you don't need to dam rivers and streams and run miles of lines to cities. The power can be produced in large warehouses and power the cities from within. They can also be used as emergency power for peak demand or for disasters.

I think the AC/DC power units will help clean up the air thus helping Everyone on the planet

1. I claim that the AC/DC SELF GENERATING MOTOR SYSTEM will become the new drive unit for vehicles in the near future. The AC/DC system does not require any type of fossil fuel to run on but relies on a self generating power supply. The AC/DC system replaces the fuel burning engines in vehicles. This system is not bound to vehicles only but can also adapted for use on power generators used by the utility companies. Utility companies will be able to use old warehouses as power plants. Now power can be produced locally without diverting rivers or drilling into the ground for geysers to run generators. No more long transmission lines, just local power plants safe for the environment and the air. The AC/DC system is safe for all the planets inhabitants.
